(19) United States
(12) Patent Application Publication
(10) Pub. No.: US 2025/0153807 A1
(43) Pub. Date: May 15, 2025

(54) Bottom bracket transmission with a planetary design for a bicycle or a pedelec

(71) Applicant: ZF Friedrichshafen AG, Friedrichshafen (DE)

(72) Inventors: Stefan Beck, Eriskirch (DE); Michael Wechs, Weißensberg (DE); Fabian Kutter, Kressbronn (DE); Thomas Martin, Weissensberg (DE); Thomas Riedisser, Sigmarszell (DE)

(21) Appl. No.: 18/944,610

(22) Filed: Nov. 12, 2024

(30) Foreign Application Priority Data
Nov. 13, 2023 (DE) 102023211232.9

(51) Int. Cl. B62M 11/14; B62M 11/18

(52) U.S. Cl. CPC B62M 11/145; B62M 11/18

(57) ABSTRACT

A bottom bracket transmission with a planetary design for a bicycle or a pedelec (1) includes a pedal crankshaft (WAn), a transmission output shaft (WAb), further shafts (W1, W2, W3, W4, W5, W6, W7), and a first transmission shifting group (3) and a second transmission shifting group (4) coupled together for implementing a plurality of gears (G1, G2, G3, G4, G5, G6, G7, G8, G9, G10, G11, G12). The first transmission shifting group (3) includes a two-stage stepped planetary gear set (StRS1).

### CROSS-REFERENCE TO RELATED APPLICATION

The present application is related and has right of priority to German Patent Application No. DE102023211232.9 filed on Nov. 13, 2023, which is incorporated by reference in its entireties for all purposes.

### TECHNICAL FIELD

The present invention relates generally to a bottom bracket transmission with a planetary design for a bicycle or a pedelec. The invention further relates generally to a bicycle or pedelec with the bottom bracket transmission.

### BACKGROUND

A transmission in a pedal crankshaft housing for a bicycle or pedelec is disclosed, for example, in the publication DE 10 2022 203 243 B3. The transmission includes a stepped planetary gear set and a further planetary gear set which are arranged coaxially to the pedal crankshaft, to which six shifting elements are assigned for implementing six gears.

### SUMMARY

Example aspects of the present invention provide a bottom bracket transmission and a bicycle or pedelec including the bottom bracket transmission requiring as little construction effort and having properties which are improved relative to the prior art.

Thus, a bottom bracket transmission with a planetary design for a bicycle or a pedelec is provided. The bottom bracket transmission has a pedal crankshaft as a drive and a transmission output shaft as an output and further shafts, wherein the output is preferably implemented via a chain wheel, a belt wheel, or the like. Moreover, the bottom bracket transmission includes a first transmission shifting group and a second transmission shifting group which are coupled to each other for implementing a plurality of gears, wherein the first transmission shifting group includes a two-stage stepped planetary gear set to which three shifting elements are assigned, wherein a first shaft as an input shaft of the first stepped planetary gear set is connected to a second ring gear as an element of the first stepped planetary gear set, wherein a fifth shaft as an output shaft of the first stepped planetary gear set is connected to a first ring gear as an element of the first stepped planetary gear set, wherein a second sun gear as an element of the first stepped planetary gear set can be fixed to a housing or to a stationary component or the like via a first shifting element, wherein a first sun gear as an element of the first stepped planetary gear set can be fixed to the housing via a second shifting element, wherein a stepped planetary gear carrier as an element of the first stepped planetary gear set is rotatably mounted, and wherein for blocking the stepped planetary gear set two elements of the first stepped planetary gear set can be connected to each other via a fifth shifting element, so that in theory ten blocking variants which are equally effective are possible.

In this manner, a particularly simple and compact construction in the bottom bracket transmission is implemented by the above-described connection of the first transmission shifting group in the bottom bracket transmission with a designated stepped planetary gear set and only three designated shifting elements. In addition, there are particularly small component loads and an advantageously high gearing efficiency due to the geometric gear range in the bottom bracket transmission relative to the known transmission.

Preferably, in addition to the drive and output, further shafts or shaft-like elements are used for the mechanical connection of elements, for example rotary elements or the like, of the two planetary gear sets in the two transmission shifting groups, wherein the term shaft is not to be understood to mean exclusively a cylindrical rotatably mounted machine element for transmitting torques but rather this is also understood to mean general connecting elements which connect the individual gear set elements to each other for the torque transmission.

The axial sequence of the two transmission shifting groups can be exchanged in the bottom bracket transmission. Accordingly, the first transmission shifting group is connected upstream or downstream of the second transmission shifting group between the transmission input shaft or the pedal crankshaft and the transmission output shaft of the bottom bracket transmission. In an upstream arrangement of the first transmission shifting group, a pedal crank of the bottom bracket transmission, which is connected to the transmission input shaft or pedal crankshaft, is effectively connected to the first shaft as an input shaft of the first transmission shifting group, and the fifth shaft of the first transmission shifting group is connected on the input side to the second transmission shifting group. It is possible that the pedal crankshaft and the first shaft are designed in one piece or even in multiple pieces. In a downstream arrangement of the first transmission shifting group, the first shaft is connected on the output side to the second transmission shifting group and the fifth shaft of the first transmission shifting group is connected to the transmission output shaft. It is possible that the transmission output shaft and the fifth shaft are designed in one piece or multiple pieces.

In the bottom bracket transmission, a multigear second transmission shifting group of any design can be combined with the first transmission shifting group as a bottom bracket transmission. Preferably, the second transmission shifting group can be designed as a two-gear transmission or a two-gear group or as a three-gear transmission or a three-gear group or as a four-gear transmission or a four-gear group and the first transmission shifting group can be designed as a three-gear transmission or a three-gear group, so that for example a six-gear transmission or a nine-gear transmission or a ten-gear transmission or a twelve-gear transmission can be implemented as the bottom bracket transmission. However, other numbers of gears can also be implemented in the transmission shifting groups, so that the bottom bracket transmission can also implement a larger or smaller number of gears. Depending on the boundary conditions and requirements in the bottom bracket transmission, gears can also be omitted. In this manner, the gear set can be optimized to the required gear ratios (gear steps, spread, etc.) or even to the type of shifting, and how many shifting elements are involved.

For connecting the second transmission shifting group, for achieving a particularly simple and compact construction of the bottom bracket transmission, it can be provided that the second transmission shifting group includes a first planetary gear set to which a third shifting element and a sixth shifting element are assigned, wherein in the second transmission shifting group a second element of the first planetary gear set is connected to the pedal crankshaft or to the fifth shaft as an output shaft of the first stepped planetary gear set, wherein a first element of the first planetary gear set can be fixed to the housing via the third shifting element, wherein a third element of the first planetary gear set is connected to the transmission output shaft or to the first shaft as an input shaft of the first stepped planetary gear set, and wherein for blocking the first planetary gear set two elements of the first planetary gear set can be connected to each other via the sixth shifting element.

One example embodiment of the invention for connecting the second transmission shifting group, for achieving a particularly simple and compact construction of the bottom bracket transmission, can provide that the second transmission shifting group includes a first planetary gear set and a second planetary gear set to which a third shifting element, a fourth shifting element, and a sixth shifting element are assigned, wherein in the second transmission shifting group a second element of the first planetary gear set is connected to the pedal crankshaft or to the fifth shaft as an output shaft of the first stepped planetary gear set, wherein a first element of the first planetary gear set and a first element of the second planetary gear set are connected to the transmission output shaft or to the first shaft as an input shaft of the first stepped planetary gear set, wherein a third element of the first planetary gear set can be fixed to the housing via the third shifting element, wherein the third element of the first planetary gear set is connected to a second element of the second planetary gear set, wherein a third element of the second planetary gear set can be fixed to the housing via the fourth shifting element, and wherein for blocking the first planetary gear set and the second planetary gear set two elements of the planetary gear sets can be connected to each other via the sixth shifting element.

A further example embodiment of the invention for connecting the second transmission shifting group, for achieving a particularly simple and compact construction of the bottom bracket transmission, can provide that the second transmission shifting group includes a second stepped planetary gear set to which a third shifting element, a fourth shifting element and a sixth shifting element are assigned, wherein in the second transmission shifting group a second ring gear as an element of the second stepped planetary gear set is connected to the pedal crankshaft or to the fifth shaft as an output shaft of the first stepped planetary gear set, wherein a second ring gear as an element of the second stepped planetary gear set is connected to the transmission output shaft or to the first shaft as an input shaft of the first stepped planetary gear set, wherein the stepped planetary gear carrier as an element of the second stepped planetary gear set can be fixed to the housing via the third shifting element, wherein a sun gear as an element of the second stepped planetary gear set can be fixed to the housing via the fourth shifting element, and wherein for blocking the second stepped planetary gear set two elements of the second stepped planetary gear set can be connected to each other via the sixth shifting element.

A further example embodiment of the invention for connecting the second transmission shifting group, for achieving a particularly simple and compact construction of the bottom bracket transmission, can provide that the second transmission shifting group includes a first planetary gear set and a second planetary gear set to which a third shifting element, a fourth shifting element, a sixth shifting element and a seventh shifting element are assigned, wherein in the second transmission shifting group a second element of the first planetary gear set is connected to the pedal crankshaft or to the fifth shaft as an output shaft of the first stepped planetary gear set, wherein a first element of the first planetary gear set is connected to the transmission output shaft or to the first shaft as an input shaft of the first stepped planetary gear set, wherein a third element of the first planetary gear set is connected to a second element of the second planetary gear set, wherein a third element of the second planetary gear set can be fixed to the housing via the third shifting element and can be connected to the pedal crankshaft via the sixth shifting element or can be connected to the fifth shaft as an output shaft of the first stepped planetary gear set, and wherein a first element of the second planetary gear set can be fixed to the housing via the fourth shifting element, and can be connected via the seventh shifting element to the transmission output shaft or to the first shaft as an input shaft of the first stepped planetary gear set.

In addition, a further example embodiment of the invention for connecting the second transmission shifting group, for achieving a particularly simple and compact construction of the bottom bracket transmission, can provide that the second transmission shifting group includes a first two-gear group and a second two-gear group, wherein the first two-gear group is assigned the third shifting element and the sixth shifting element, and wherein the second two-gear group is assigned the fourth shifting element and the seventh shifting element. It is also provided that in the first two-gear group a second element of the first planetary gear set is connected to the pedal crankshaft or to the fifth shaft as an output shaft of the first stepped planetary gear set, that a third element of the first planetary gear set is connected to a second element of the second planetary gear set, that a first element of the first planetary gear set can be fixed to the housing via the third shifting element, that for blocking the first planetary gear set two elements of the first planetary gear set can be connected to each other via the sixth shifting element, that a first element of the second planetary gear set is connected to the transmission output shaft or to the first shaft as an input shaft of the first stepped planetary gear set, that a third element of the second planetary gear set can be fixed to the housing via the fourth shifting element, and that for blocking the second planetary gear set two elements of the second planetary gear set can be connected to each other via the seventh shifting element. In addition to exchanging the sequence of the two transmission shifting groups, an exchange of the two-gear groups is also effectively possible in the direction of the flux of force or in the axial direction.

Within the scope of example aspects of the invention, in the bottom bracket transmission with the two transmission shifting groups it is provided that the designated shifting elements can be designed as brakes, freewheel brakes, clutches and/or freewheels. An advantageous example variant of the invention provides that the first shifting element, the second shifting element, the third shifting element and the fourth shifting element are designed in each case as a positive brake and/or that the fifth shifting element, the sixth shifting element and the seventh shifting element are designed in each case as a freewheel.

The shifting elements designed as brakes are preferably designed as positive shifting elements, for example as cost-effective brake claws or shift claws or the like, for example with a toothed brake ring and a corresponding shifting pawl. Brakes as shifting elements have the advantage that brakes can be easily accessed from outside for actuation. In the clutches designed as freewheels, it is advantageous if the brakes are designed, for example, as one-way brakes in order to prevent a blocking of the transmission when reversing the direction of rotation on the drive or on the output. Preferably, non-actively shiftable or actuatable freewheels are used as freewheels. This has the advantage that no shifting actuation is required in the passive shifting elements. The non-actuatable freewheel transmits a torque when the freewheel locks in the reverse direction state. In the opposing direction of rotation, no torque is transmitted since the freewheel does not lock in the overrunning state. However, it is conceivable that actively shiftable freewheels or even actively shiftable freewheel brakes can also be used.

A preferred example embodiment of the invention can provide that at least one of the designated planetary gear sets is designed as minus planetary gear set, resulting in a particularly space-saving arrangement. It is also conceivable that one of the planetary gear sets is designed as a plus planetary gear set.

A minus planetary gear set can preferably be transferred into a plus planetary gear set if the planetary gear carrier and ring gear connection to this gear set are exchanged with each other and the amount of the stationary gear ratio is increased by one (1). A minus planetary gear set has rotatably mounted planetary gears on its planetary gear carrier, which mesh with the sun gear and the ring gear of this planetary gear set so that, when the planetary gear carrier is fixed and the sun gear rotates, the ring gear rotates in the direction opposing the direction of rotation of the sun gear. A plus planetary gear set has inner and outer planetary gears which are rotatably mounted on its planetary gear carrier and which are in toothed engagement with each other, wherein the sun gear of this planetary gear set meshes with the inner planetary gears and the ring gear of this planetary gear set meshes with the outer planetary gears so that, when the planetary gear carrier is fixed and the sun gear rotates, the ring gear rotates in the same direction of rotation as the direction of rotation of the sun gear.

This means for a person skilled in the art that in the individual gear sets, which are designed as a minus planetary gear set, a first element or gear set element is designed as a sun gear, a second element is designed as a planetary gear carrier or web and a third element is designed as a ring gear. This also means that in an individual gear set, which is designed as a plus planetary gear set, the first element is designed as a sun gear, the second element is designed as a ring gear and the third element is designed as a planetary gear carrier or web.

In order to optimize further the activation of the proposed bottom bracket transmission, it is provided that at least one torque sensor, or the like, is provided on the drive and/or on the output.

In order to provide electrical assistance to the drive in the proposed bottom bracket transmission, at least one electric machine, or the like, can be connected or is connectable or can be fixedly or releasably coupled to the drive or to the pedal crankshaft or transmission input shaft and/or to the output or transmission output shaft. Preferably, the electric machine can be arranged axially parallel to the pedal crankshaft or transmission input shaft while the planetary gear sets are arranged coaxially to the pedal crankshaft or transmission input shaft.

A further example aspect of the present invention provides a bicycle or pedelec with the above-described bottom bracket transmission. The already described advantages and further advantages are found therein.

### BRIEF DESCRIPTION OF THE DRAWINGS

Example aspects of the present invention are explained further hereinafter by way of the drawings, in which:

FIG. 1 shows a schematic basic view of a bottom bracket transmission according to example embodiments of the invention on a bicycle or a pedelec with a first transmission shifting group with a stepped planetary gear set connected upstream of a second transmission shifting group, with a first blocking variant;

FIG. 2 shows a schematic basic view of the bottom bracket transmission according to example embodiments of the invention with the first transmission shifting group with the stepped planetary gear set connected downstream of the second transmission shifting group, with a first blocking variant;

FIG. 3 shows a schematic basic view of the bottom bracket transmission according to example embodiments of the invention with the first transmission shifting group with the stepped planetary gear set connected upstream of the second transmission shifting group, with a second blocking variant;

FIG. 4 shows a schematic basic view of the bottom bracket transmission according to example embodiments of the invention with the first transmission shifting group with the stepped planetary gear set connected upstream of the second transmission shifting group, with a third blocking variant;

FIG. 5 shows a schematic basic view of the bottom bracket transmission according to example embodiments of the invention with the first transmission shifting group with the stepped planetary gear set connected upstream of the second transmission shifting group, with a fourth blocking variant;

FIG. 6 shows a schematic basic view of the bottom bracket transmission according to example embodiments of the invention with the first transmission shifting group with the stepped planetary gear set connected upstream of the second transmission shifting group, with a fifth blocking variant;

FIG. 7 shows a schematic basic view of the bottom bracket transmission according to example embodiments of the invention with the first transmission shifting group with the stepped planetary gear set connected upstream of the second transmission shifting group, with a sixth blocking variant;

FIG. 8 shows a schematic basic view of the bottom bracket transmission according to example embodiments of the invention with the first transmission shifting group with the stepped planetary gear set connected upstream of the second transmission shifting group, with a seventh blocking variant;

FIG. 9 shows a schematic basic view of the bottom bracket transmission according to example embodiments of the invention with the first transmission shifting group with the stepped planetary gear set connected upstream of the second transmission shifting group, with an eighth blocking variant;

FIG. 10 shows a gearshift diagram with three shiftable gears of the first transmission shifting group in the bottom bracket transmission;

FIG. 11 shows a schematic basic view of the bottom bracket transmission with an example embodiment of the second transmission shifting group as a two-gear transmission connected upstream of the first transmission shifting group as a three-gear transmission;

FIG. 12 shows a gearshift diagram of the six-gear bottom bracket transmission according to FIG. 11;

FIG. 13 shows a schematic basic view of the bottom bracket transmission with an example embodiment of the second transmission shifting group with two planetary gear sets connected downstream of the first transmission shifting group as a three-gear transmission;

FIG. 14 shows a schematic basic view of the bottom bracket transmission with an example embodiment of the second transmission shifting group with a second stepped planetary gear set connected downstream of the first transmission shifting group as a three-gear transmission;

FIG. 15 shows a gearshift diagram of the nine-gear bottom bracket transmission according to FIGS. 13 and 14;

FIG. 16 shows a schematic basic view of the bottom bracket transmission with an example embodiment of the second transmission shifting group with two planetary gear sets connected downstream of the first transmission shifting group as a three-gear transmission;

FIG. 17 shows a gearshift diagram of the ten-gear bottom bracket transmission according to FIG. 16;

FIG. 18 shows a schematic basic view of the bottom bracket transmission with an example embodiment of the second transmission shifting group with two two-gear groups connected downstream of the first transmission shifting group as a three-gear transmission;

FIG. 19 shows a gearshift diagram of the twelve-gear bottom bracket transmission according to FIG. 18;

FIG. 20 shows a schematic basic view of the bottom bracket transmission according to FIG. 1 with a torque sensor on the drive indicated by way of example;

FIG. 21 shows a schematic basic view of the bottom bracket transmission according to FIG. 20 with an electric machine arranged by way of example on the drive;

FIG. 22 shows a schematic basic view of the bottom bracket transmission according to FIG. 20 with an electric machine arranged by way of example on the output; and

FIG. 23 shows a schematic basic view of the bottom bracket transmission according to FIG. 20 with a freewheel upstream of the pedal crankshaft.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

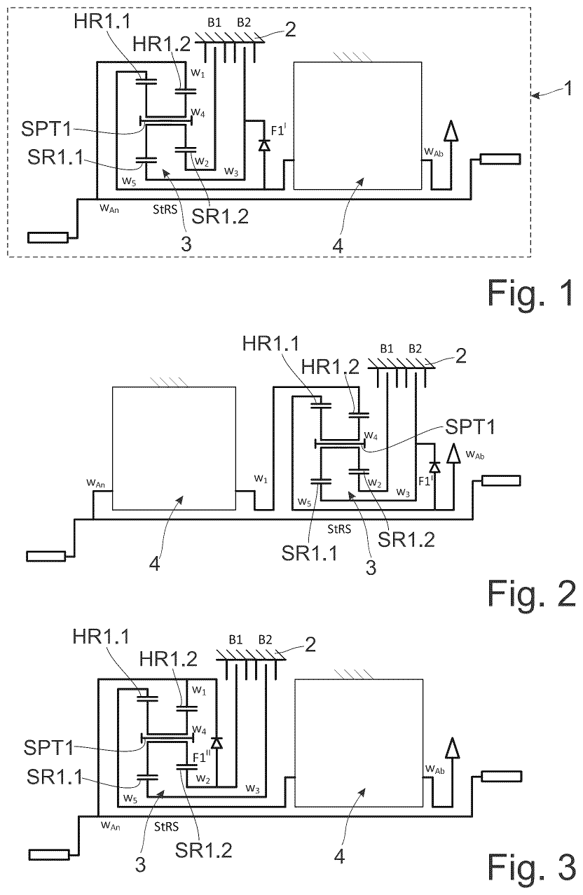

Different variants and embodiments or gearshift diagrams of a bottom bracket transmission with a planetary design according to example aspects of the invention are shown in FIGS. 1 to 23 merely by way of example. FIG. 1 shows by way of example a bicycle or pedelec 1 with the bottom bracket transmission indicated merely schematically.

The bottom bracket transmission is shown in a housing or bottom bracket housing 2 with a pedal crank with pedals as the pedal crankshaft WAn, wherein the pedal crankshaft WAn is connected on the input side to one of the transmission shifting groups 3, 4. The bottom bracket transmission also includes a transmission output shaft WAb as an output with a chain wheel or belt wheel, not shown further, which is connected on the output side to one of the transmission shifting groups 3, 4. The bottom bracket transmission includes a multigear first transmission shifting group 3 and a multigear second transmission shifting group 4, wherein the first transmission shifting group 3 has a two-stage stepped planetary gear set StRS1 to which a first shifting element B1 as a positive brake, a second shifting element B2 as a positive brake and a fifth shifting element F1^{I}, F1^{II}, F1^{III}, F1^{IV}, F1^{V}, F1^{VI}, F1^{VII}, F1^{VIII} as a freewheel are assigned. The two transmission shifting groups 3, 4 effectively form two sub-transmissions which can be interconnected to each other in any sequence relative to the direction of the flux of force between the pedal crankshaft WAn and the transmission output shaft WAb.

Independently of the respective example variants, in the bottom bracket transmission it is provided that a first shaft W1 is connected as an input shaft of the first stepped planetary gear set StRS1 to a second ring gear HR1.2 as an element of the first stepped planetary gear set StRS1, that a fifth shaft W5 as an output shaft of the first stepped planetary gear set StRS1 is connected to a first ring gear HR1.1 as an element of the first stepped planetary gear set StRS1, that a second sun gear SR1.2 as an element of the first stepped planetary gear set StRS1 can be fixed to a housing 2 via the first shifting element B1, that a first sun gear SR1.1 as an element of the first stepped planetary gear set StRS1 can be fixed to the housing 2 via the second shifting element B2, that a stepped planetary wheel carrier SPT1 as an element of the first stepped planetary gear set StRS1 is rotatably mounted, and that for blocking the stepped planetary gear set StRS1 two elements of the first stepped planetary gear set StRS1 can be connected to each other via the fifth shifting element F1^{I}, F1^{II}, F1^{III}, F1^{IV}, F1^{V}, F1^{VI}, F1^{VII}, F1^{VIII}.

In FIGS. 11, 13, 14, 16, and 18, the designated planetary gear sets RS1, RS2 are designed in each case as space-saving minus planetary gear sets. It is provided here in each case that a sun gear SR1, SR2 is provided as a first element, a web or planetary gear carrier PT1, PT2 is provided as a second element and a ring gear HR1, HR2 is provided as a third element in the planetary gear sets RS1, RS2.

In FIG. 1, a variant of the bottom bracket transmission is shown in which the first transmission shifting group 3 is connected upstream of the second transmission shifting group 4. In detail, in the first variant according to FIG. 1 it is provided that the first shaft W1 as an input shaft of the first stepped planetary gear set StRS1 of the first transmission shifting group 3 is connected to the pedal crankshaft WAn or is configured in one piece therewith, that the first shaft W1 is connected to the second ring gear HR1.2 of the first stepped planetary gear set StRS1, that the first ring gear HR1.1 of the first stepped planetary gear set StRS1 is connected on the input side to the second transmission shifting group 4 via the fifth shaft W5, that the stepped planetary gear carrier SPT1 of the first stepped planetary gear set StRS1 is rotatably mounted via a fourth shaft W4, that the second sun gear SR1.2 of the first stepped planetary gear set StRS1 can be fixed to the housing 2 via a second shaft W2 when the first shifting element B1 is engaged, that the first sun gear SR1.1 of the first stepped planetary gear set StRS1 can be fixed to the housing 2 via a third shaft W3 when the second shifting element B2 is engaged, and that for blocking the first stepped planetary gear set StRS1, as a first blocking variant, the first sun gear SR1.1 can be connected to the first ring gear HR1.1 when the fifth shifting element F1^{I} is locked, in a first arrangement variant of the fifth shifting element F1^{I}.

In FIG. 2, a variant of the bottom bracket transmission is shown in which the first transmission shifting group 3 is connected downstream of the second transmission shifting group 4. In detail, in the variant according to FIG. 2 it is provided that the first shaft W1 as an input shaft of the first stepped planetary gear set StRS1 is connected on the output side to the second transmission shifting group 4, that the first shaft W1 is connected to the second ring gear HR1.2 of the stepped planetary gear set StRS1, that the first ring gear HR1.1 of the first stepped planetary gear set StRS1 is connected to the fifth shaft W5, that the fifth shaft W5 as an output shaft of the first transmission shifting group is connected to the transmission output shaft WAb or is configured in one piece therewith, that the stepped planetary gear carrier SPT1 of the first stepped planetary gear set StRS1 is rotatably mounted via the fourth shaft W4, that the second sun gear SR1.2 of the first stepped planetary gear set StRS1 can be fixed to the housing 2 via the second shaft W2 when the first shifting element B1 is engaged, that the first sun gear SR1.1 of the first stepped planetary gear set StRS1 can be fixed to the housing 2 via the third shaft W3 when the second shifting element B2 is engaged, and that for blocking the first stepped planetary gear set StRS1, as a first blocking variant, the first sun gear SR1.1 can be connected to the first ring gear HR1.1 when the fifth shifting element F1^{I} is locked, in a first arrangement variant of the fifth shifting element F1^{I}.

In FIG. 3, a second blocking variant of the first stepped planetary gear set StRS1 is shown in which the first transmission shifting group 3 is connected upstream of the second transmission shifting group 4. In the context of the second blocking variant, the second sun gear SR1.2 is connected to the second ring gear HR1.2 of the first stepped planetary gear set StR1 when the fifth shifting element F1^{II} is engaged, in a second arrangement variant.

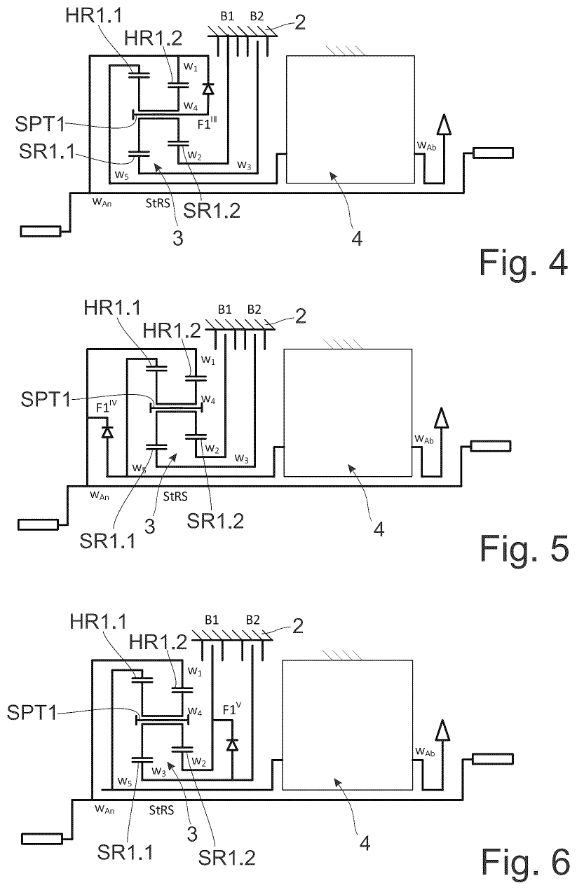

In FIG. 4, a third blocking variant of the first stepped planetary gear set StRS1 is shown in which the first transmission shifting group 3 is connected upstream of the second transmission shifting group 4. In the context of the third blocking variant, the stepped planetary gear carrier SPT1 is connected to the second ring gear HR1.2 of the first stepped planetary gear set StR1 when the fifth shifting element F1^{III} is engaged, in a third arrangement variant.

In FIG. 5, a fourth blocking variant of the first stepped planetary gear set StRS1 is shown in which the first transmission shifting group 3 is connected upstream of the second transmission shifting group 4. In the context of the fourth blocking variant, the first ring gear HR1.1 is connected to the second ring gear HR1.2 of the first stepped planetary gear set StR1 when the fifth shifting element F1^{IV} is engaged, in a fourth arrangement variant.

In FIG. 6, a fifth blocking variant of the first stepped planetary gear set StRS1 is shown in which the first transmission shifting group 3 is connected upstream of the second transmission shifting group 4. In the context of the fifth blocking variant, the first sun gear SR1.1 is connected to the second sun gear SR1.2 of the first stepped planetary gear set StR1 when the fifth shifting element F1^{V} is engaged, in a fifth arrangement variant.

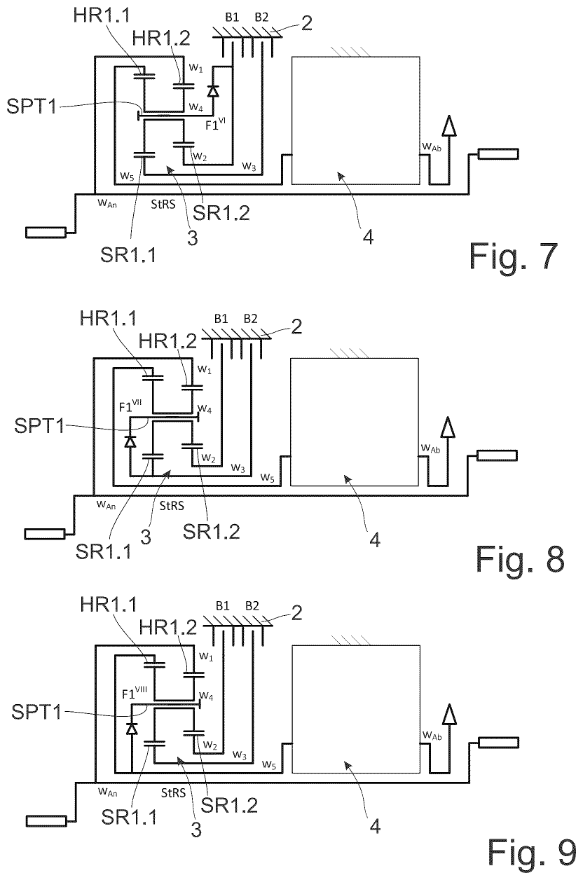

In FIG. 7, a sixth blocking variant of the first stepped planetary gear set StRS1 is shown in which the first transmission shifting group 3 is connected upstream of the second transmission shifting group 4. In the context of the sixth blocking variant, the second sun gear SR1.2 is connected to the stepped planetary gear carrier SPT1 of the first stepped planetary gear set StR1 when the fifth shifting element F1^{VI} is engaged, in a sixth arrangement variant.

In FIG. 8, a seventh blocking variant of the first stepped planetary gear set StRS1 is shown in which the first transmission shifting group 3 is connected upstream of the second transmission shifting group 4. In the context of the seventh blocking variant, the first sun gear SR1.1 is connected to the stepped planetary gear carrier SPT1 of the first stepped planetary gear set StR1 when the fifth shifting element F1^{VII} is engaged, in a seventh arrangement variant.

In FIG. 9, an eighth blocking variant of the first stepped planetary gear set StRS1 is shown in which the first transmission shifting group 3 is connected upstream of the second transmission shifting group 4. In the context of the eighth blocking variant, the first ring gear HR1.1 is connected to the stepped planetary gear carrier SPT1 of the first stepped planetary gear set StR1 when the fifth shifting element F1^{VIII} is engaged, in an eighth arrangement variant.

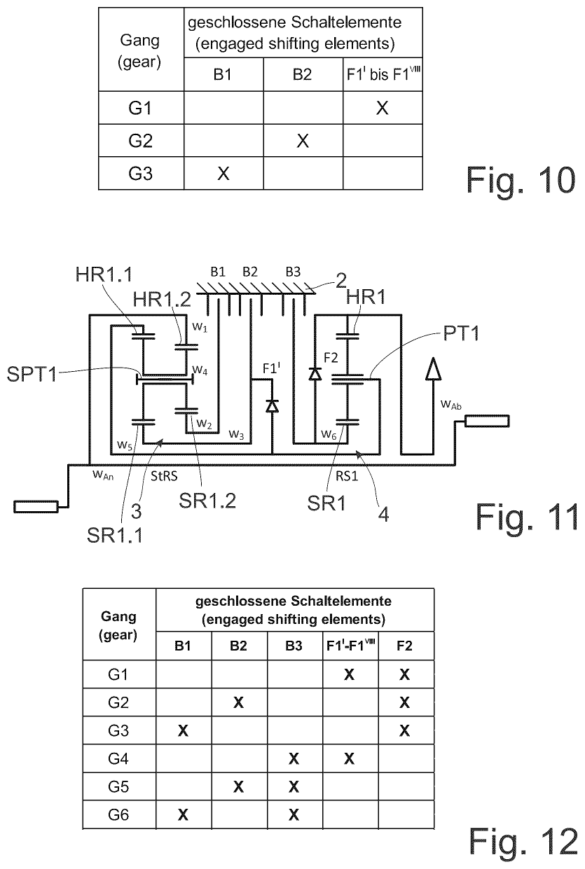

In FIG. 10, a gearshift diagram is shown for the first transmission shifting group 3 as a three-gear transmission. It follows therefrom that three gears G1, G2, G3 can be implemented by the first transmission shifting group 3. The shifting elements B1, B2, F1^{I}, F1^{II}, F1^{III}, F1^{IV}, F1^{V}, F1^{VI}, F1^{VII}, F1^{VIII} used for the respective gear G1, G2, G3 are specified in the gearshift diagram. Here an X in the freewheel F1^{I}, F1^{II}, F1^{III}, F1^{IV}, F1^{V}, F1^{VI}, F1^{VII}, F1^{VIII} as a shifting element in the gearshift diagram means that the freewheel locks. This functions automatically without external actuation. Moreover, an X in a brake B1, B2 as a shifting element in the gearshift diagram means that the brake B1, B2 is engaged. This functions via a suitable actuator system. An empty field in the freewheel F1^{I}, F1^{II}, F1^{III}, F1^{IV}, F1^{V}, F1^{VI}, F1^{VII}, F1^{VIII} means that the freewheel does not lock. An empty field in the brakes B1, B2 means that the brakes are disengaged.

In detail, it follows from the gearshift diagram according to FIG. 10 that for implementing or shifting a first gear G1 the first shifting element F1^{I}, F1^{II}, F1^{III}, F1^{IV}, F1^{V}, F1^{VI}, F1^{VII}, F1^{VIII} designed as a freewheel locks, that for implementing a second gear G2 the second shifting element B2 designed as a brake is engaged, and/or for implementing a third gear G3 the first shifting element B1 designed as a brake is engaged.

In FIG. 11, the bottom bracket transmission is shown by way of example with a first transmission shifting group 3 as a three-gear transmission group and with a second transmission shifting group 4 as a two-gear transmission group with a first planetary gear set RS1 to which a third shifting element B3 as a brake and a sixth shifting element F2 as a freewheel are assigned. In detail, for connecting the second transmission shifting group 4 to the first transmission shifting group 3, it is provided that the planetary gear carrier PT1 of the first planetary gear set RS1 is connected to the fifth shaft W5 as an output shaft of the first stepped planetary gear set StRS1, that the sun gear SR1 of the first planetary gear set RS1 can be fixed to the housing 2 via a sixth shaft W6 when the third shifting element B3 is engaged, that the ring gear HR1 of the first planetary gear set RS1 is connected to the transmission output shaft WAb and that for blocking the first planetary gear set RS1, in a first blocking variant, the ring gear HR1 can be connected to the sun gear of the first planetary gear set RS1 when the sixth shifting element F2 is locked. The two further blocking variants are implemented by the further connection options of the elements of the first planetary gear set RS1. The connections of the first stepped planetary gear set StRS1 in the first transmission shifting group 3 have been already described above.

In FIG. 12, a gearshift diagram is shown for the bottom bracket transmission shown in FIG. 11 with the first transmission shifting group 3 as a three-gear transmission and with the second transmission shifting group 4 as a two-gear transmission. It follows therefrom that 4×2, i.e. six, gears G1, G2, G3, G4, G5, G6 can be implemented. The shifting elements B1, B2, B3, F1^{I}, F1^{II}, F1^{III}, F1^{IV}, F1^{V}, F1^{VI}, F1^{VII}, F1^{VIII}, F2 used for the respective gear G1, G2, G3, G4, G5, G6 are specified in the gearshift diagram. Here an X in the freewheels F1^{I}, F1^{II}, F1^{III}, F1^{IV}, F1^{V}, F1^{VI}, F1^{VII}, F1^{VIII}, F2 as shifting elements in the gearshift diagram means that the freewheels lock. This functions automatically without external actuation. Moreover, an X in a brake B1, B2, B3 as a shifting element in the gearshift diagram means that the brakes B1, B2, B3 are engaged. This functions via a suitable actuator system. An empty field in the freewheels F1^{I}, F1^{II}, F1^{III}, F1^{IV}, F1^{V}, F1^{VI}, F1^{VII}, F1^{VIII}, F2 means that the freewheels do not lock. An empty field in the brakes B1, B2, B3 means that the brakes are disengaged.

In detail, it follows from the gearshift diagram according to FIG. 12 that for implementing or shifting a first gear G1 the fifth shifting element F1^{I}, F1^{II}, F1^{III}, F1^{IV}, F1^{V}, F1^{VI}, F1^{VII}, F1^{VIII} designed as a freewheel and the sixth shifting element F2 designed as a freewheel lock, that for implementing a second gear G2 the second shifting element B2 designed as a brake is engaged and that the sixth shifting element F2 designed as a freewheel locks, that for implementing a third gear G3 the first shifting element B1 designed as a brake is engaged and the sixth shifting element F2 designed as a freewheel locks, that for implementing a fourth gear G4 the third shifting element B3 designed as a brake is engaged and the fifth shifting element F1^{I}, F1^{II}, F1^{III}, F1^{IV}, F1^{V}, F1^{VI}, F1^{VII}, F1^{VIII} designed as a freewheel locks, that for implementing a fifth gear G5 the second shifting element B2 designed as a brake and the third shifting element B3 designed as a brake are engaged and/or that for implementing a sixth gear G6 the first shifting element B1 designed as a brake and the third shifting element B3 designed as a brake are engaged.

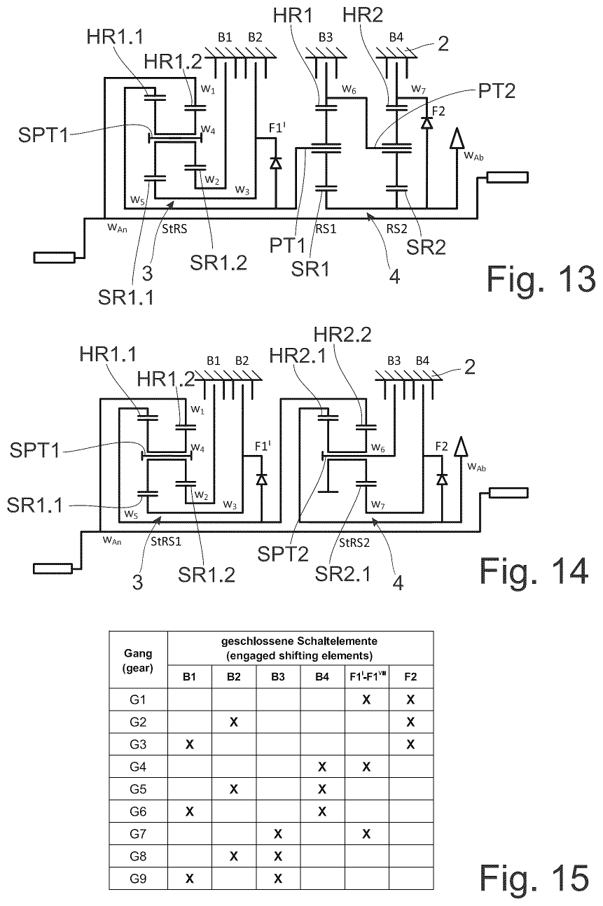

In FIG. 13, the bottom bracket transmission is shown by way of example with a first transmission shifting group 3 as a three-gear transmission group and with a second transmission shifting group 4 as a three-gear transmission group with a first planetary gear set RS1 and a second planetary gear set RS2, to which a third shifting element B3 as a brake, a fourth shifting element B4 as a brake and a sixth shifting element F2 as a freewheel are assigned. In detail, for connecting the second transmission shifting group 4 to the first transmission shifting group 3 it is provided that the planetary gear carrier PT1 of the first planetary gear set RS1 is connected to the fifth shaft W5 as an output shaft of the first stepped planetary gear set StRS1, that the sun gear SR1 of the first planetary gear set RS1 and the sun gear SR2 of the second planetary gear set RS2 are connected together to the transmission output shaft WAb, that the ring gear HR1 of the first planetary gear set RS1 can be fixed to the housing 2 via a sixth shaft W6 when the third shifting element B3 is engaged, that the ring gear HR1 of the first planetary gear set RS1 is fixedly connected to the planetary gear carrier PT2 of the second planetary gear set RS2 via the sixth shaft W6, that the ring gear HR2 of the second planetary gear set RS2 can be fixed to the housing 2 via a seventh shaft W7 when the fourth shifting element B4 is engaged, and that for blocking the first planetary gear set RS1 and the second planetary gear set RS2, in the context of a first blocking variant, the transmission output shaft WAb which is connected to the two sun gears SR1 and SR2 of the two planetary gear sets RS1 and RS2 when the sixth shifting element F2 is blocked, in a first arrangement variant, can be connected to the seventh shaft W7 which is connected to the ring gear HR2 of the second planetary gear set RS2. For implementing the further blocking variants, more of the six elements of the two planetary gear sets RS1, RS2 are connected to each other via the sixth shifting element F2. The connections of the first stepped planetary gear set StRS1 in the first transmission shifting group 3 have been already described above.

In FIG. 14, the bottom bracket transmission is shown by way of example with a first transmission shifting group 3 as a three-gear transmission group and with a second transmission shifting group 4 as three-gear transmission group with a second stepped planetary gear set StRS2, to which a third shifting element B3 as a brake, a fourth shifting element B4 as a brake and a sixth shifting element F2 as a freewheel are assigned. In detail, for connecting the second transmission shifting group 4 to the first transmission shifting group 3 it is provided that the second ring gear HR2.2 as an element of the second stepped planetary gear set StRS2 is connected to the fifth shaft W5 as an output shaft of the first stepped planetary gear set StRS1, that the first ring gear HR2.1 as an element of the second stepped planetary gear set StRS2 is connected to the transmission output shaft WAb, that the stepped planetary gear carrier SPT2 as an element of the second stepped planetary gear set StRS2 can be fixed to the housing 2 via a sixth shaft W6 when the third shifting element B3 is engaged, that the sun gear SR2.1 as an element of the second stepped planetary gear set StRS2 can be fixed to the housing 2 via a seventh shaft W7 when the fourth shifting element B4 is engaged, and that for blocking the second stepped planetary gear set StRS2, in the context of a first blocking variant, the sun gear SR2.1 can be connected to the first ring gear HR2.1 of the second stepped planetary gear set StRS2 when the sixth shifting element F2 is locked, in a first arrangement variant. The further blocking variants are implemented by the further connection options of the four elements of the second stepped planetary gear set StRS2. The connections of the first stepped planetary gear set StRS1 in the first transmission shifting group 3 have already been described above.

In FIG. 15, a gearshift diagram is shown for the bottom bracket transmission shown in FIGS. 13 and 14 with the first transmission shifting group 3 as a three-gear transmission and with the second transmission shifting group 4 as a three-gear transmission. It follows therefrom that 3×3, i.e. nine, gears G1, G2, G3, G4, G5, G6, G7, G8, G9 can be implemented. The shifting elements B1, B2, B3, B4, F1′, F1^{I}, F1^{II}, F1^{III}, F1^{IV}, F1^{V}, F1^{VI}, F1^{VII}, F1^{VIII}, F2 used for the respective gear G1, G2, G3, G4, G5, G6, G7, G8, G9 are specified in the gearshift diagram. Here an X in the freewheels F1^{I}, F1^{II}, F1^{III}, F1^{IV}, F1^{V}, F1^{VI}, F1^{VII}, F1^{VIII}, F2 as shifting elements in the gearshift diagram means that the freewheels lock. This functions automatically without external actuation. Moreover, an X in a brake B1, B2, B3, B4 as a shifting element in the gearshift diagram means that the brakes B1, B2, B3, B4 are engaged. This functions via a suitable actuator system. An empty field in the freewheels F1^{I}, F1^{II}, F1^{III}, F1^{IV}, F1^{V}, F1^{VI}, F1^{VII}, F1^{VIII}, F2 means that the freewheels do not lock. An empty field in the brakes B1, B2, B3, B4 means that the brakes are disengaged.

In detail, it follows from the gearshift diagram according to FIG. 15 that for implementing or shifting a first gear G1 the fifth shifting element F1^{I}, F1^{II}, F1^{III}, F1^{IV}, F1^{V}, F1^{VI}, F1^{VII}, F1^{VIII} designed as a freewheel and the sixth shifting element F2 designed as a freewheel lock, that for implementing a second gear G2 the second shifting element B2 designed as a brake is engaged and the sixth shifting element F2 designed as a freewheel locks, that for implementing a third gear G3 the first shifting element B1 designed as a brake is engaged and the sixth shifting element F2 designed as a freewheel locks, that for implementing a fourth gear G4 the fourth shifting element B4 designed as a brake is engaged and the fifth shifting element F1^{I}, F1^{II}, F1^{III}, F1^{IV}, F1^{V}, F1^{VI}, F1^{VII}, F1^{VIII} designed as a freewheel locks, that for implementing a fifth gear G5 the second shifting element B2 designed as a brake and the fourth shifting element B4 designed as a brake are engaged, that for implementing a sixth gear G6 the first shifting element B1 designed as a brake and the fourth shifting element B4 designed as a brake are engaged, that for implementing a seventh gear G7 the third shifting element B3 designed as a brake is engaged and the fifth shifting element F1^{I}, F1^{II}, F1^{III}, F1^{IV}, F1^{V}, F1^{VI}, F1^{VII}, F1^{VIII} designed as a freewheel locks, that for implementing an eighth gear G8 the second shifting element B2 designed as a brake and the third shifting element B3 designed as a brake are engaged, and/or that for implementing a ninth gear G9 the first shifting element B1 designed as a brake and the third shifting element B3 designed as a brake are engaged.

In FIG. 16, the bottom bracket transmission is shown by way of example with a first transmission shifting group 3 as a three-gear transmission group and with a second transmission shifting group 4 with a first planetary gear set RS1 and a second planetary gear set RS2, to which a third shifting element B3 as a brake, a fourth shifting element B4 as a brake, a sixth shifting element F2 as a freewheel and a seventh shifting element F3 as a freewheel are assigned. In detail, for connecting the second transmission shifting group 4 to the first transmission shifting group 3 it is provided that the planetary gear carrier PT1 of the first planetary gear set RS1 is connected to the fifth shaft W5 as an output shaft of the first stepped planetary gear set StRS1, that the sun gear SR1 of the first planetary gear set RS1 is connected to the transmission output shaft WAb, that the ring gear HR1 of the first planetary gear set RS1 is fixedly connected to the planetary gear carrier PT2 of the second planetary gear set RS2 via a sixth shaft W6, that the ring gear HR2 of the second planetary gear set RS2 can be fixed to the housing 2 via a seventh shaft W7 when the third shifting element B3 is engaged, and can be connected to the fifth shaft W5 as an output shaft of the first stepped planetary gear set StRS1 when the sixth shifting element F2 is locked, and that the sun gear SR2 of the second planetary gear set RS2 can be fixed to the housing 2 via an eighth shaft W8 when the fourth shifting element B4 is engaged, and can be connected to the transmission output shaft WAb when the seventh shifting element F3 is locked. The connections of the first stepped planetary gear set StRS1 in the first transmission shifting group 3 have already been described above.

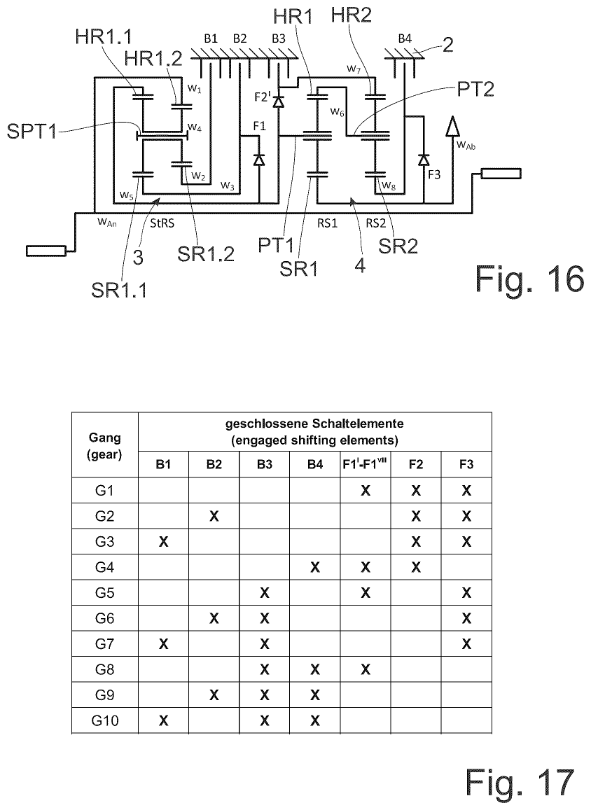

In FIG. 17, a gearshift diagram is shown for the bottom bracket transmission shown in FIG. 16, with the first transmission shifting group 3 as a three-gear transmission and with the second transmission shifting group 4. It follows therefrom that ten gears G1, G2, G3, G4, G5, G6, G7, G8, G9, G10 can be implemented. The shifting elements B1, B2, B3, B4, F1^{I}, F1^{II}, F1^{III}, F1^{IV}, F1^{V}, F1^{VI}, F1^{VII}, F1^{VIII}, F2, F3 used for the respective gear G1, G2, G3, G4, G5, G6, G7, G8, G9, G10 are specified in the gearshift diagram. Here an X in the freewheels F1^{I}, F1^{II}, F1^{III}, F1^{IV}, F1^{V}, F1^{VI}, F1^{VII}, F1^{VIII}, F2, F3 as shifting elements in the gearshift diagram means that the freewheels lock. This functions automatically without external actuation. Moreover, an X in a brake B1, B2, B3, B4 as a shifting element in the gearshift diagram means that the brakes B1, B2, B3, B4 are engaged. This functions via a suitable actuator system. An empty field in the freewheels F1^{I}, F1^{II}, F1^{III}, F1^{IV}, F1^{V}, F1^{VI}, F1^{VII}, F1^{VIII}, F2, F3 means that the freewheels do not lock. An empty field in the brakes B1, B2, B3, B4 means that the brakes are disengaged.

In detail, it follows from the gearshift diagram according to FIG. 17 that for implementing or shifting a first gear G1 the fifth shifting element F1^{I}, F1^{II}, F1^{III}, F1^{IV}, F1^{V}, F1^{VI}, F1^{VII}, F1^{VIII} designed as a freewheel, the sixth shifting element F2 designed as a freewheel and the seventh shifting element F3 designed as a freewheel lock, that for implementing a second gear G2 the second shifting element B2 designed as a brake is engaged and the sixth shifting element F2 designed as a freewheel and the seventh shifting element F3 designed as a freewheel lock, that for implementing a third gear G3 the first shifting element B1 designed as a brake is engaged and the sixth shifting element F2 designed as a freewheel and the seventh shifting element F3 designed as a freewheel lock, that for implementing a fourth gear G4 the fourth shifting element B4 designed as a brake is engaged and the fifth shifting element F1^{I}, F1^{II}, F1^{III}, F1^{IV}, F1^{V}, F1^{VI}, F1^{VII}, F1^{VIII} designed as a freewheel and the sixth shifting element F2 designed as a freewheel lock, that for implementing a fifth gear G5 the third shifting element B3 designed as a brake is engaged and the fifth shifting element F1^{I}, F1^{II}, F1^{III}, F1^{IV}, F1^{V}, F1^{VI}, F1^{VII}, F1^{VIII} designed as a freewheel and the seventh shifting element F3 designed as a freewheel lock, that for implementing a sixth gear G6 the second shifting element B2 designed as a brake and the third shifting element B3 designed as a brake are engaged and the seventh shifting element F3 designed as a freewheel locks, that for implementing a seventh gear G7 the first shifting element B1 designed as a brake and the third shifting element B3 designed as a brake are engaged and the seventh shifting element F3 designed as a freewheel locks, that for implementing an eighth gear G8 the third shifting element B3 designed as a brake and the fourth shifting element B4 designed as a brake are engaged and the fifth shifting element F1^{I}, F1^{II}, F1^{III}, F1^{IV}, F1^{V}, F1^{VI}, F1^{VII}, F1^{VIII} designed as a freewheel locks, that for implementing a ninth gear G9 the second shifting element B2 designed as a brake, the third shifting element B3 designed as a brake and the fourth shifting element B4 designed as a brake are engaged and/or that for implementing a tenth gear G10 the first shifting element B1 designed as a brake, the third shifting element B3 designed as a brake and the fourth shifting element B4 designed as a brake are engaged.

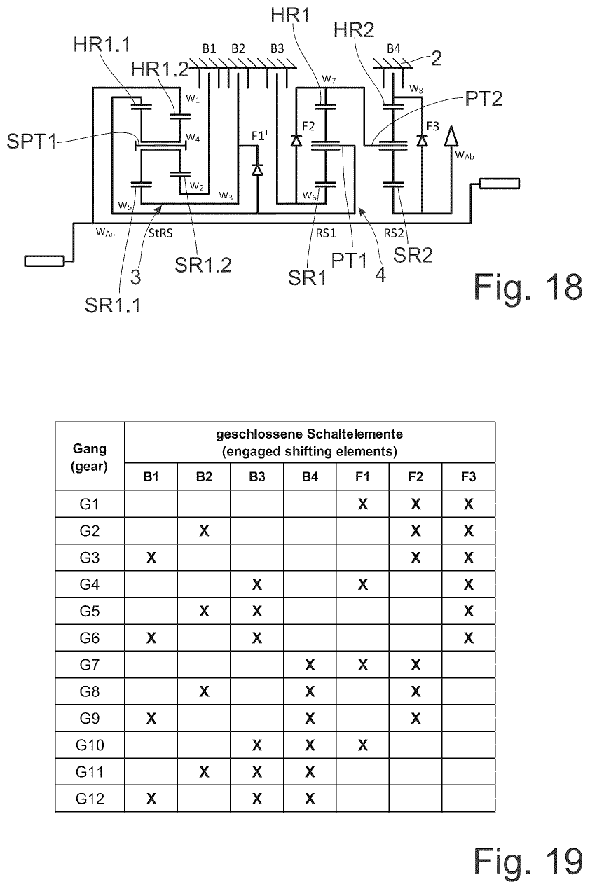

In FIG. 18, the bottom bracket transmission is shown by way of example with a first transmission shifting group 3 as a three-gear transmission group and with a second transmission shifting group 4 as a first two-gear group and as a second two-gear group with a first planetary gear set RS1 and a second planetary gear set RS2, to which a third shifting element B3 as a brake, a fourth shifting element B4 as a brake, a sixth shifting element F2 as a freewheel and a seventh shifting element F3 as a freewheel are assigned. In detail, for connecting the second transmission shifting group 4 to the first transmission shifting group 3 it is provided that in the first two-gear group the planetary gear carrier PT1 of the first planetary gear set RS1 is connected to the fifth shaft W5 as an output shaft of the first stepped planetary gear set StRS1, that the ring gear HR1 of the first planetary gear set RS1 is connected to the planetary gear carrier PT2 of the second planetary gear set RS2 via a seventh shaft W7, that the sun gear SR1 of the first planetary gear set RS1 can be fixed to the housing 2 via a sixth shaft W6 when the third shifting element B3 is engaged, that for blocking the first planetary gear set RS1, in the context of a first blocking variant, the sun gear SR1 can be connected to the ring gear HR1 of the first planetary gear set RS1 when the sixth shifting element F2 is locked, in a first arrangement variant, wherein the further blocking variants are implemented by the use of the other elements in the first planetary gear set RS1 via the sixth shifting element F2, that in the second two-gear group the sun gear SR2 of the second planetary gear set RS2 is connected to the transmission output shaft WAb, that the ring gear HR3 of the second planetary gear set RS2 can be fixed to the housing 2 via an eighth shaft W8 when the fourth shifting element B4 is engaged, and that for blocking the second planetary gear set RS2, in the context of a first blocking variant, the sun gear SR2 can be connected to the ring gear HR2 of the second planetary gear set R2 when the seventh shifting element F3 is locked, in a first arrangement variant, wherein the further blocking variants are implemented by the use of the other elements in the second planetary gear sets RS2 via the seventh shifting element F3. The connections of the first stepped planetary gear set StRS1 in the first transmission shifting group 3 have already been described above.

In FIG. 19, a gearshift diagram is shown for the bottom bracket transmission shown in FIG. 18 with the first transmission shifting group 3 as a three-gear transmission and with the second transmission shifting group 4 with two two-gear groups. It follows therefrom that 3×2×2, i.e. twelve, gears G1, G2, G3, G4, G5, G6, G7, G8, G9, G10, G11, G12 can be implemented. The shifting elements B1, B2, B3, B4, F1^{I}, F1^{II}, F1^{III}, F1^{IV}, F1^{V}, F1^{VI}, F1^{VII}, F1^{VIII}, F2, F3 used for the respective gear G1, G2, G3, G4, G5, G6, G7, G8, G9, G10, G11, G12 are specified in the gearshift diagram. Here an X in the freewheels F1^{I}, F1^{II}, F1^{III}, F1^{IV}, F1^{V}, F1^{VI}, F1^{VII}, F1^{VIII}, F2, F3 as shifting elements in the gearshift diagram means that the freewheels lock. This functions automatically without external actuation. Moreover, an X in a brake B1, B2, B3, B4 as a shifting element in the gearshift diagram means that the brakes B1, B2, B3, B4 are engaged. This functions via a suitable actuator system. An empty field in the freewheels F1^{I}, F1^{II}, F1^{III}, F1^{IV}, F1^{V}, F1^{VI}, F1^{VII}, F1^{VIII}, F2, F3 means that the freewheels do not lock. An empty field in the brakes B1, B2, B3, B4 means that the brakes are disengaged.

In detail, it follows from the gearshift diagram according to FIG. 19 that for implementing or shifting a first gear G1 the fifth shifting element F1^{I}, F1^{II}, F1^{III}, F1^{IV}, F1^{V}, F1^{VI}, F1^{VII}, F1^{VIII} designed as a freewheel, the sixth shifting element F2 designed as a freewheel and the seventh shifting element F3 designed as a freewheel lock, that for implementing a second gear G2 the second shifting element B2 designed as a brake is engaged and the sixth shifting element F2 designed as a freewheel and the seventh shifting element F3 designed as a freewheel lock, that for implementing a third gear G3 the first shifting element B1 designed as a brake is engaged and the sixth shifting element F2 designed as a freewheel and the seventh shifting element F3 designed as a freewheel lock, that for implementing a fourth gear G4 the third shifting element B3 designed as a brake is engaged and the fifth shifting element F1^{I}, F1^{II}, F1^{III}, F1^{IV}, F1^{V}, F1^{VI}, F1^{VII}, F1^{VIII} designed as a freewheel and the seventh shifting element F3 designed as a freewheel lock, that for implementing a fifth gear G5 the second shifting element B2 designed as a brake and the third shifting element B3 designed as a brake and the seventh shifting element F3 designed as a freewheel lock, that for implementing a sixth gear G6 the first shifting element B1 designed as a brake and the third shifting element B3 designed as a brake are engaged, and the seventh shifting element F3 designed as a freewheel locks, that for implementing a seventh gear G7 the fourth shifting element B4 designed as a brake is engaged and the fifth shifting element F1^{I}, F1^{II}, F1^{III}, F1^{IV}, F1^{V}, F1^{VI}, F1^{VII}, F1^{VIII} designed as a freewheel and the sixth shifting element F2 designed as a freewheel lock, that for implementing an eighth gear G8 the second shifting element B2 designed as a brake and the fourth shifting element B4 designed as a brake are engaged and the sixth shifting element F2 designed as a freewheel locks, that for implementing a ninth gear G9 the first shifting element B1 designed as a brake and the fourth shifting element B4 designed as a brake are engaged and the sixth shifting element F2 designed as a freewheel locks, that for implementing a tenth gear G10 the third shifting element B3 designed as a brake and the fourth shifting element B4 designed as a brake are engaged and the fifth shifting element F1^{I}, F1^{II}, F1^{III}, F1^{IV}, F1^{V}, F1^{VI}, F1^{VII}, F1^{VIII} designed as a freewheel locks, that for implementing an eleventh gear G11 the second shifting element B2 designed as a brake, the third shifting element B3 designed as a brake and the fourth shifting element B4 designed as a brake are engaged, and/or that for implementing a twelfth gear G12 the first shifting element B1 designed as a brake, the third shifting element B3 designed as a brake and the fourth shifting element B4 designed as a brake are engaged.

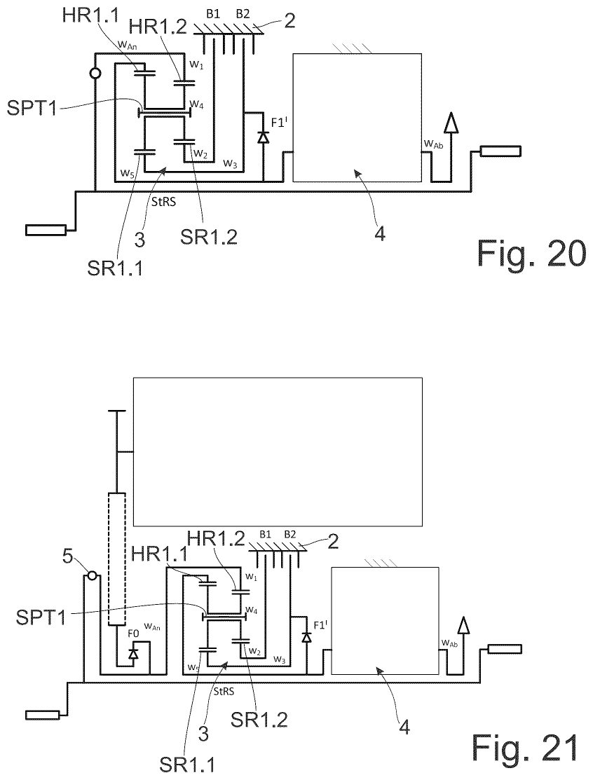

In FIG. 20, an embodiment of the bottom bracket transmission according to example aspects of the invention is shown with reference to FIG. 1 in which a torque sensor 5 is connected or can be connected to the pedal crankshaft or to the transmission input shaft WAn. For example, a disk-shaped torque sensor 5 can be arranged on the gear input. However, the torque sensor 5 can also be designed in a different manner.

In FIGS. 21 and 22, an embodiment of the bottom bracket transmission according to example aspects of the invention is shown in each case with reference to FIG. 20 with an additional electric machine EM. The electric machine EM can be connected to the pedal crankshaft WAn, as indicated in FIG. 21. It is also conceivable that the electric machine EM is connected to the transmission output shaft WAb, as shown in FIG. 22. The electric machine EM is preferably arranged axially parallel to the pedal crankshaft or transmission input shaft WAn. However, a coaxial arrangement of the electric machine EM to the pedal crankshaft could also be possible. Irrespective thereof, it is advantageous to connect the electric machine EM via a freewheel F0 or the like, so that during operation without the electric machine EM no losses are caused by the electric machine EM rotating therewith.

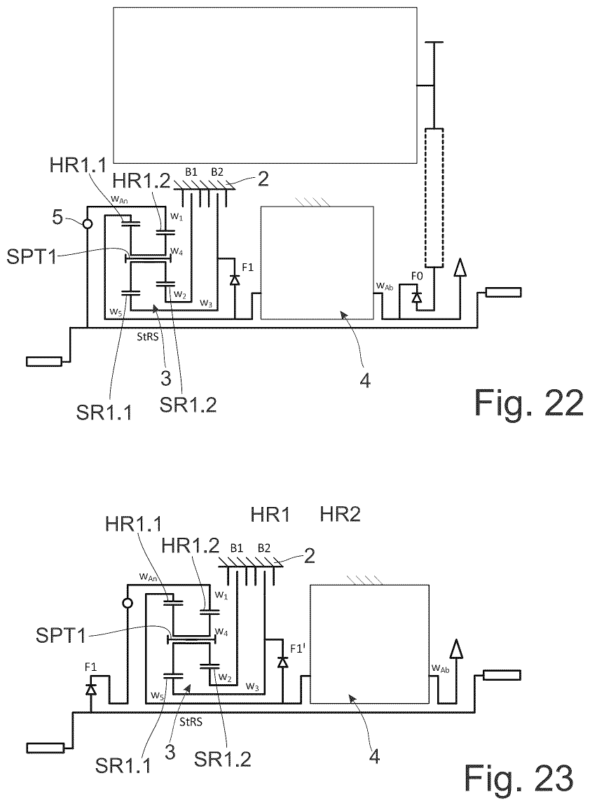

In FIG. 23, an embodiment of the bottom bracket transmission according to example aspects of the invention is shown with reference to FIG. 20 with an additional freewheel F between the pedal crank and the transmission input of the bottom bracket transmission. In this manner when the pedalling is interrupted, the freewheel can open and uncouples the pedal crank from the inertia masses of the transmission gear set and, in particular, the electric machine EM so that no inertia forces can be perceived on the pedal.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 Bicycle or pedelec
2 Housing or bottom bracket housing
3 First transmission shifting group
4 Second transmission shifting group
5 Torque sensor
EM Electric machine
F0 Freewheel for electric machine
F Additional freewheel
SR1 Sun gear of first planetary gear set
PT1 Planetary gear carrier of first planetary gear set
HR1 Ring gear of first planetary gear set
SR2 Sun gear of second planetary gear set
PT2 Planetary gear carrier of second planetary gear set
HR2 Ring gear of second planetary gear set
SR1.1 First sun gear with larger number of teeth of first stepped planetary gear set
SRI.2 Second sun gear with smaller number of teeth of first stepped planetary gear set
HR1.1 First ring gear with larger number of teeth of first stepped planetary gear set,
HR1.2 Second ring gear with smaller number of teeth of first stepped planetary gear set,
SPT1 Stepped planetary gear carrier of first stepped planetary gear set
SR2.1 Sun gear of second stepped planetary gear set
HR2.1 First ring gear with larger number of teeth of second stepped planetary gear set
HR2.2 Second ring gear with smaller number of teeth of second stepped planetary gear set
SPT2 Stepped planetary gear carrier of second stepped planetary gear set
RS1 First planetary gear set
RS2 Second planetary gear set
StRS1 First stepped planetary gear set
StRS2 Second stepped planetary gear set
WAn Transmission input shaft or pedal crankshaft
WAb Transmission output shaft
W1 First shaft
W2 Second shaft
W3 Third shaft
W4 Fourth shaft
W5 Fifth shaft
W6 Sixth shaft
W7 Seventh shaft
W8 Eighth shaft
G1 First gear
G2 Second gear
G3 Third gear
G4 Fourth gear
G5 Fifth gear
G6 Sixth gear
G7 Seventh gear
G8 Eighth gear
G9 Ninth gear
G10 Tenth gear
G11 Eleventh gear
G12 Twelfth gear
B1 First shifting element designed as a brake
B2 Second shifting element designed as a brake
B3 Third shifting element designed as a brake
B4 Fourth shifting element designed as a brake
F1^{I} Fifth shifting element designed as a freewheel in a first arrangement position
F1^{II} Fifth shifting element designed as a freewheel in a second arrangement position
F1^{III} Fifth shifting element designed as a freewheel in a third arrangement position
F1^{IV} Fifth shifting element designed as a freewheel in a fourth arrangement position
F1^{V} Fifth shifting element designed as a freewheel in a fifth arrangement position
F1^{VI} Fifth shifting element designed as a freewheel in a sixth arrangement position
F1^{VII} Fifth shifting element designed as a freewheel in a seventh arrangement position
F1^{VIII} Fifth shifting element designed as a freewheel in an eighth arrangement position
F2 Sixth shifting element designed as a freewheel
F3 Seventh shifting element designed as a freewheel

1-17: (canceled)

18. A bottom-bracket transmission with a planetary design for a bicycle or a pedelec (1), comprising:
a pedal crankshaft (WAn) as a drive;
a transmission output shaft (WAb) as an output;
a plurality of shafts (W1, W2, W3, W4, W5, W6, W7); and
a first transmission shifting group (3) and a second transmission shifting group (4) coupled together for implementing a plurality of gears (G1, G2, G3, G4, G5, G6, G7, G8, G9, G10, G11, G12), the first transmission shifting group (3) comprising a two-stage stepped planetary gear set (StRS1) to which three shifting elements (B1, B2, F1I, F1II, F1III, F1IV, F1V, F1VI, F1VII, F1VIII) are assigned,
wherein a first shaft (W1) of the plurality of shafts as an input shaft of the first stepped planetary gear set (StRS1) is connected to a second ring gear (HR1.2) of the first stepped planetary gear set (StRS1),
wherein a fifth shaft (W5) of the plurality of shafts as an output shaft of the first stepped planetary gear set (StRS1) is connected to a first ring gear (HR1.1) of the first stepped planetary gear set (StRS1),
wherein a second sun gear (SR1.2) of the first stepped planetary gear set (StRS1) is fixable to a housing (2) via a first shifting element (B1),
wherein a first sun gear (SR1.1) of the first stepped planetary gear set (StRS1) is fixable to the housing (2) via a second shifting element (B2),
wherein a stepped planetary gear carrier (SPT1) of the first stepped planetary gear set (StRS1) is rotatably mounted, and
wherein, for blocking the stepped planetary gear set (StRS1), two elements of the first stepped planetary gear set (StRS1) are connectable via a fifth shifting element (F1I, F1II, F1III, F1IV, F1V, F1VI, F1VII, F1VIII).

19. The bottom-bracket transmission of claim 18, wherein the first transmission shifting group (3) is connected upstream or downstream of the second transmission shifting group (4).

20. The bottom-bracket transmission of claim 18, wherein:
the second transmission shifting group (4) comprises a first planetary gear set (RS1) to which a third shifting element (B3), and a sixth shifting element (F2) are assigned;
in the second transmission shifting group (4), a second element of the first planetary gear set (RS1) is connected to the pedal crankshaft (WAn) or to the fifth shaft (W5);
a first element of the first planetary gear set (RS1) is fixable to the housing (2) via the third shifting element (B3);
a third element of the first planetary gear set (RS1) is connected to the transmission output shaft (WAb) or to the first shaft (W1); and
for blocking the first planetary gear set (RS1), two elements of the first planetary gear set (RS1) are connectable via the sixth shifting element (F2).

21. The bottom-bracket transmission of claim 18, wherein:
the second transmission shifting group (4) comprises a first planetary gear set (RS1) and a second planetary gear set (RS2) to which a third shifting element (B3), a fourth shifting element (B4), and a sixth shifting element (F2) are assigned;
in the second transmission shifting group (4), a second element of the first planetary gear set (RS1) is connected to the pedal crankshaft (WAn) or to the fifth shaft (W5);
a first element of the first planetary gear set (RS1) and a first element of the second planetary gear set (RS2) are connected to the transmission output shaft (WAb) or to the first shaft (W1);
a third element of the first planetary gear set (RS1) is fixable to the housing (2) via the third shifting element (B3);
the third element of the first planetary gear set (RS1) is connected to a second element of the second planetary gear set (RS2);
a third element of the second planetary gear set (RS2) is fixable to the housing (2) via the fourth shifting element (B4); and
for blocking the first planetary gear set (RS1) and the second planetary gear set (RS2), two shafts connected to elements of the planetary gear sets (RS1, RS2) are connectable to each other via the sixth shifting element (F2).

22. The bottom-bracket transmission of claim 18, wherein:
the second transmission shifting group (4) comprises a second stepped planetary gear set (StRS2) to which a third shifting element (B3), a fourth shifting element (B4), and a sixth shifting element (F2) are assigned;
in the second transmission shifting group (4), a second ring gear (HR2.2) of the second stepped planetary gear set (StRS2) is connected to the pedal crankshaft (WAn) or to the fifth shaft W5;
a first ring gear (HR2.1) of the second stepped planetary gear set (StRS2) is connected to the transmission output shaft (WAb) or to the first shaft (W1);
a stepped planetary gear carrier (SPT2) of the second stepped planetary gear set (StRS2) is fixable to the housing (2) via the third shifting element (B3);
a sun gear (SR2.1) of the second stepped planetary gear set (StRS2) is fixable to the housing (2) via the fourth shifting element (B4); and
for blocking the second stepped planetary gear set (StRS2), two elements of the second stepped planetary gear set (StRS2) are connectable via the sixth shifting element (F2).

23. The bottom-bracket transmission of claim 18, wherein:
the second transmission shifting group (4) comprises a first planetary gear set (RS1) and a second planetary gear set (RS2) to which a third shifting element (B3), a fourth shifting element (B4), a sixth shifting element (F2), and a seventh shifting element (F3) are assigned;
in the second transmission shifting group (4), a second element of the first planetary gear set (RS1) is connected to the pedal crankshaft (WAn) or to the fifth shaft (W5);
a first element of the first planetary gear set (RS1) is connected to the transmission output shaft (WAb) or to the first shaft (W1);
a third element of the first planetary gear set (RS1) is connected to a second element of the second planetary gear set (RS2);
a third element of the second planetary gear set (RS2) is fixable to the housing (2) via the third shifting element (B3) and is connectable to the pedal crankshaft (WAn) via the sixth shifting element (B3) or connectable to the fifth shaft (W5); and
a first element of the second planetary gear set (RS2) is fixable to the housing (2) via the fourth shifting element (B4) and is connectable via the seventh shifting element (F3) to the transmission output shaft (WAb) or to the first shaft (W1).

24. The bottom-bracket transmission of claim 18, wherein:
the second transmission shifting group (4) comprises a first two-gear group and a second two-gear group;
the first two-gear group is assigned the third shifting element (B3) and the sixth shifting element (F2); and
the second two-gear group is assigned the fourth shifting element (B4) and the seventh shifting element (F3).

25. The bottom-bracket transmission of claim 24, wherein:
in the first two-gear group, a second element of the first planetary gear set (RS1) is connected to the pedal crankshaft (WAn) or to the fifth shaft (W5);
a third element of the first planetary gear set (RS1) is connected to a second element of the second planetary gear set (RS2);
a first element of the first planetary gear set (RS1) is fixable to the housing (2) via the third shifting element (B3);
for blocking the first planetary gear set (RS1), two elements of the first planetary gear set (RS1) are connectable via the sixth shifting element (F2);
in the first two-gear group, a first element of the second planetary gear set (RS2) is connected to the transmission output shaft (WAb) or to the first shaft (W1);
a third element of the second planetary gear set (RS2) is fixable to the housing (2) via the fourth shifting element (B4); and
for blocking the second planetary gear set (RS2), two elements of the second planetary gear set (RS2) are connectable via the seventh shifting element (F3).

26. The bottom-bracket transmission of claim 18, wherein one or both of:
the first shifting element (B1), the second shifting element (B2), the third shifting element (B3), and the fourth shifting element (B4) are each a positive brake; and
the fifth shifting element (F1I, F1II, F1III, F1IV, F1V, F1VI, F1VII, F1VIII), the sixth shifting element (F2), and the seventh shifting element (F3) are each a freewheel.

27. The bottom-bracket transmission of claim 18, wherein one or both of the first planetary gear set (RS1) and the second planetary gear set (RS2) is a respective minus planetary gear set.

28. The bottom-bracket transmission of claim 27, wherein, in the minus planetary gear set, the first element is a sun gear (SR1, SR2), the second element is a planetary gear carrier (PT1, PT2), and the third element is a ring gear (HR1, HR2).

29. The bottom-bracket transmission of claim 18, wherein one or both of the first planetary gear set (RS1) and the second planetary gear set (RS2) is a respective plus planetary gear set.

30. The bottom-bracket transmission of claim 29, wherein, in the plus planetary gear set, the first element is a sun gear (SR1, SR2), the second element is a ring gear (HR1, HR2), and the third element is a planetary gear carrier (PT1, PT2).

31. The bottom-bracket transmission of claim 18, further comprising a torque sensor (5) connected to the pedal crankshaft (WAn).

32. The bottom-bracket transmission of claim 18, further comprising an electric machine (EM) connected or connectable to the pedal crankshaft (WAn) or to the transmission output shaft (WAb).

33. The bottom-bracket transmission of claim 32, wherein the electric machine (EM) is arranged axially parallel to the pedal crankshaft (WAn).

34. A bicycle or pedelec (1), comprising the bottom bracket transmission of claim 18.
